(19) United States
(12) Patent Application Publication
(10) Pub. No.: US 2025/0213908 A1
(43) Pub. Date: Jul. 3, 2025

(54) FLUID STERILIZATION DEVICE

(71) Applicant: TOYODA GOSEI CO., LTD., Kiyosu-shi (JP)

(72) Inventor: Satoshi WADA, Kiyosu-shi (JP)

(21) Appl. No.: 18/975,029

(22) Filed: Dec. 10, 2024

(30) Foreign Application Priority Data
Dec. 28, 2023 (JP) 2023-222214

(51) Int. Cl. A62D 3/176

(52) U.S. Cl. CPC A62D 3/176

(57) ABSTRACT

A fluid sterilization device includes: a sterilization chamber body that includes a sterilization chamber for a fluid, a wall surface of which being formed in a concave spherical shape, the sterilization chamber body being formed such that a light source opening, a chamber inlet that allows the fluid to flow into the sterilization chamber, and a chamber outlet that allows the fluid to flow out of the sterilization chamber are formed to open into the sterilization chamber; and a light source unit configured to close the light source opening and emit ultraviolet light from the light source opening into the sterilization chamber. The light source unit includes a light-emitting element that emits ultraviolet light, and the light source opening is formed such that an edge line of the light source opening is included in a region that constitutes −10° to +10° around a half-value angle the light-emitting element.

### CROSS-REFERENCE TO RELATED APPLICATIONS

This application is based on and claims priority under 35 USC 119 from Japanese Patent Application No. 2023-222214 filed on Dec. 28, 2023, the entire content of which is incorporated herein by reference.

### TECHNICAL FIELD

The present disclosure relates to a fluid sterilization device.

### BACKGROUND ART

JP2023-6710A discloses a fluid sterilization device that uses a light-emitting element that emits ultraviolet light. The fluid sterilization device includes a substantially concave spherical-shaped sterilization chamber (reservoir) that accommodates a fluid, a chamber inlet (supply port) that allows the fluid to flow into the sterilization chamber, a chamber outlet (drain port) that allows the fluid to be drained from the sterilization chamber, and a light source unit that emits ultraviolet light.

The sterilization chamber includes a substantially semi-concave spherical-shaped first sterilization chamber positioned upstream in a flow direction of the fluid at the chamber inlet, and a substantially semi-concave spherical-shaped second sterilization chamber positioned downstream. The chamber inlet is formed on a first sterilization chamber side, and the chamber outlet is formed on a second sterilization chamber side. The light source unit is disposed on the second sterilization chamber side.

### SUMMARY OF INVENTION

In the fluid sterilization device, the light source unit is disposed in a light source opening of the sterilization chamber. The light-emitting element that constitutes the light source unit emits ultraviolet light, and the emitted ultraviolet light is emitted from the light source opening to an inside of the sterilization chamber.

In order to increase sterilization efficiency inside the sterilization chamber, it is required to thoroughly irradiate the inside of the sterilization chamber with the ultraviolet light emitted from the light source unit.

However, depending on a light emission characteristic of the light-emitting element and a positional relation between a position of the light-emitting element and the light source opening, the sterilization efficiency in the sterilization chamber may decrease.

Aspects of the present disclosure relate to providing a fluid sterilization device capable of increasing sterilization efficiency.

According to an aspect of the present disclosure, there is provided a fluid sterilization device including:
a sterilization chamber body that includes a sterilization chamber for a fluid, a wall surface of the sterilization chamber being formed in a concave spherical shape, the sterilization chamber body being formed such that a light source opening, a chamber inlet that allows the fluid to flow into the sterilization chamber, and a chamber outlet that allows the fluid to flow out of the sterilization chamber are formed to open into the sterilization chamber; and
a light source unit configured to close the light source opening and emit ultraviolet light from the light source opening into the sterilization chamber, in which
the light source unit includes a light-emitting element that emits ultraviolet light, and
the light source opening is formed such that an edge line of the light source opening is included in a region that constitutes −10° to +10° around a half-value angle the light-emitting element.

According to the above aspect, the edge line of the light source opening is positioned to be included in the region that constitutes −10° to +10° around a half-value angle of the light-emitting element. The half-value angle of the light-emitting element is an angle at which an illuminance is 50% of a maximum illuminance with an optical axis positioned in a center direction in a spread of a light distribution characteristic as a central axis. As described above, −10° to +10° around the half-value angle of the light-emitting element is an angle at which the illuminance is approximately 50% of the maximum illuminance. Therefore, the region that constitutes −10° to +10° around the half-value angle of the light-emitting element is a region having an illuminance of approximately 50% or more of the maximum illuminance. That is, an illuminance of the ultraviolet light emitted from the light source opening is approximately 50% or more of the maximum illuminance. An inside of the sterilization chamber is irradiated with the ultraviolet light having the illuminance of approximately 50% or more of the maximum illuminance, and the fluid that flows through the sterilization chamber may be efficiently sterilized.

As described above, a fluid sterilization device capable of increasing sterilization efficiency may be provided.

### BRIEF DESCRIPTION OF DRAWINGS

Exemplary embodiment(s) of the present invention will be described in detail based on the following figures, wherein:

FIG. 1 is a cross-sectional view illustrating a configuration of a fluid sterilization device according to Embodiment 1;

FIG. 2 is a view schematically illustrating a flow of a fluid in the fluid sterilization device;

FIG. 3A is an exploded view of the sterilization chamber body;

FIG. 3B is a view illustrating the sterilization chamber body in an actually assembled state;

FIG. 4 is a view illustrating positions of a light source opening, a chamber inlet, and a chamber outlet when an outside of the sterilization chamber body is viewed from a direction of a central axis of the light source opening;

FIG. 5 is a cross-sectional view illustrating a configuration of a light source unit;

FIG. 6 is a view illustrating positions of a housing supply port and the light source unit when an outside of a housing is viewed from a direction of a central axis of the housing supply port;

FIG. 7 is an enlarged cross-sectional view illustrating a connection between a chamber outlet and a housing discharge port;

FIG. 8 is a diagram illustrating a result of a water flow simulation;

FIG. 9 is a cross-sectional view illustrating tangential lines of a sterilization chamber at the light source opening of the sterilization chamber body;

FIG. 10 is a diagram illustrating a light distribution characteristic of a light-emitting element that constitutes the light source unit; and

FIG. 11 is a diagram illustrating a range of a half-value angle of the light source unit.

### DESCRIPTION OF EMBODIMENTS

A fluid sterilization device includes: a sterilization chamber body that includes a sterilization chamber for a fluid, a wall surface of which is formed in a concave spherical shape, the sterilization chamber body being formed such that a light source opening, a chamber inlet that allows the fluid to flow into the sterilization chamber, and a chamber outlet that allows the fluid to flow out of the sterilization chamber are formed to open into the sterilization chamber;

and a light source unit configured to close the light source opening and emit ultraviolet light from the light source opening into the sterilization chamber. The light source unit includes a light-emitting element that emits ultraviolet light. The light source opening is formed such that an edge line of the light source opening is included in a region that constitutes −10° to +10° around a half-value angle of the light-emitting element.

The half-value angle may be 110° to 130°. For example, when the half-value angle is 110°, the following occurs. A range from +55° to −55° with respect to the optical axis, positioned in the central direction as the central axis in the spread of the light distribution characteristic of the light-emitting element, has an illuminance of 50% or more. The region that constitutes −10° to +10° around the half-value angle is a range of a light distribution angle of 100° to 120° when the optical axis is the central axis. In this case, the edge line of the light source opening is formed to be included in the range of the light distribution angle of 100° to 120°.

When the half-value angle is 120°, the edge line of the light source opening is formed to be included in a range of the light distribution angle of 110° to 130° when the optical axis is the central axis. When the half-value angle is 130°, the edge line of the light source opening is formed to be included in a range of the light distribution angle of 120° to 140° when the optical axis is the central axis.

By setting the half-value angle to 110° to 130° in this manner, ultraviolet light with high illuminance may be emitted into the concave spherical-shaped sterilization chamber. Therefore, the sterilization efficiency may be increased.

Further, the light-emitting element may have two maximum illuminance axes that are symmetrical with respect to the optical axis, positioned in the center direction in the spread of the light distribution characteristic, in a cross section that passes through the optical axis. By using the light-emitting element having such a light distribution characteristic, the inside of the sterilization chamber may be thoroughly irradiated with the ultraviolet light. As a result, the sterilization efficiency may be increased.

The edge line of the light source opening may be formed in a circular shape. Accordingly, ultraviolet light having a desired illuminance may be appropriately emitted into the sterilization chamber. As a result, the sterilization efficiency may be increased.

A ratio D/d of a diameter D of the sterilization chamber to a diameter d of the light source opening may be set in a range of 1.8 to 2.2. By setting the ratio D/d in the range of 1.8 to 2.2, the inside of the concave spherical-shaped sterilization chamber may be irradiated with the ultraviolet light having the desired illuminance.

In particular, when the half-value angle is 120° and the ratio D/d is 2.0, boundary surfaces of the half-value angle come into a state in which the boundary surfaces coincide with tangent lines at the light source opening in the sterilization chamber. Therefore, when the half-value angle is 120° and the ratio D/d is 2.0, the inside of the concave spherical-shaped sterilization chamber may be most appropriately irradiated with the ultraviolet light. Therefore, the half-value angle may be 110° to 130°, and the ratio D/d may be set in the range of 1.8 to 2.2. With such a configuration, the illuminance of the ultraviolet light emitted from the light source opening may be made equal to or higher than a half value thereof, and the sterilization efficiency may be increased.

The light-emitting element may be disposed such that the optical axis, positioned in the central direction in the spread of the light distribution characteristic, coincides with a central axis of a circle that is the edge line of the light source opening. Accordingly, the inside of the sterilization chamber may be irradiated with the ultraviolet light having the desired illuminance. Further, the chamber inlet and the chamber outlet may be disposed to face a surface

of a plane that includes the light source opening, the surface being arranged at a side of the sterilization chamber. Accordingly, the illuminance of the ultraviolet light may be set to a desired value in a vicinity of the chamber inlet and a vicinity of the chamber outlet. Further, a vicinity of an opening of a flow path at the chamber inlet and a vicinity of an opening of a flow path at the chamber outlet may be irradiated with the ultraviolet light. Thus, the sterilization efficiency may be increased.

### Embodiment 1

### 1. Basic Configuration of Fluid Sterilization Device 1

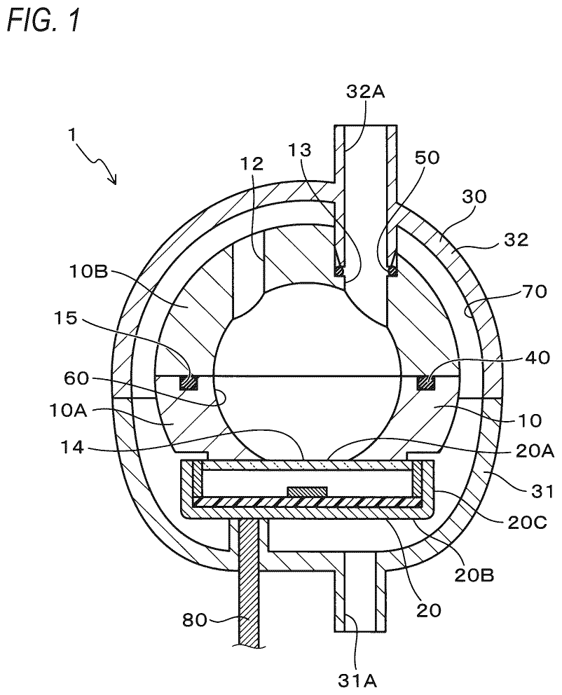

A basic configuration of a fluid sterilization device 1 will be described with reference to FIG. 1. As illustrated in FIG. 1, the fluid sterilization device 1 mainly includes a sterilization chamber body 10 that includes a sterilization chamber 60, a light source unit 20 that emits ultraviolet light into the sterilization chamber 60, and a housing 30 that encloses the sterilization chamber body 10 and the light source unit 20.

A space is formed between the sterilization chamber body 10 and the housing 30. Since the space is positioned outside the sterilization chamber body 10, the space is referred to as an outer region 70. Further, the fluid sterilization device 1 includes a first seal member 40 and a second seal member 50. The first seal member 40 and the second seal member 50 will be described later.

The fluid sterilization device 1 is a device that allows a fluid to flow into the sterilization chamber 60 from an outside thereof through the outer region 70, and irradiates the fluid in the sterilization chamber 60 with ultraviolet light from the light source unit 20 and sterilizes the fluid. The fluid to be sterilized may be a gas or a liquid, and may be a mixture of a gas and a liquid, a mixture of a gas and a powdery solid, or the like as long as the fluid has fluidity. When the fluid is a liquid, examples thereof include water, oil, alcohol, and a solution containing the same as a solvent.

The sterilization chamber body 10 includes the sterilization chamber 60 therein. The sterilization chamber 60 is a space for irradiating a flowing fluid with ultraviolet light emitted from the light source unit 20. A wall surface of the sterilization chamber 60 is formed in a concave spherical shape. By forming the sterilization chamber 60 into the concave spherical shape, the ultraviolet light may be efficiently reflected by a concave spherical surface, an illuminance of the ultraviolet light inside the sterilization chamber 60 may be increased, and thus sterilization efficiency for the fluid may be improved.

The sterilization chamber body 10 is made of a material having a high reflectance to ultraviolet light. The entire sterilization chamber body 10 is made of, for example, polytetrafluoroethylene (PTFE). By using PTFE, the reflectance to ultraviolet light may be increased, and the sterilization efficiency may be improved. A material other than PTFE may be used as long as the material has a high reflectance to ultraviolet light from the light source unit 20. In particular, the material of the sterilization chamber body 10 may be a material having a reflectance of 80% or more, preferably 90% or more, and more preferably 95% or more, to the ultraviolet light from the light source unit 20. Further, the sterilization chamber body 10 may be made such that only a surface layer that constitutes the concave spherical surface is made of a material having a reflectance of 80% or more to ultraviolet light, for example, PTFE or aluminum.

The sterilization chamber 60 is formed with a light source opening 14 that opens into the sterilization chamber body 10. The light source opening 14 is an opening that allows the ultraviolet light emitted from the light source unit 20 to enter the sterilization chamber 60.

The sterilization chamber body 10 is further formed with a chamber inlet 12 that opens into the sterilization chamber 60. The chamber inlet 12 communicates with the sterilization chamber 60 and the outer region 70. The chamber inlet 12 is an inlet that allows the fluid to flow from the outer region 70 into the sterilization chamber 60.

The sterilization chamber body 10 is further formed with a chamber outlet 13 that opens into the sterilization chamber 60. The chamber outlet 13 communicates with the sterilization chamber 60 and the outside. The chamber outlet 13 is an outlet that allows the fluid to flow out from the sterilization chamber 60 to the outside.

The light source unit 20 is disposed to close the light source opening 14. The light source unit 20 emits ultraviolet light from the light source opening 14 into the sterilization chamber 60. A portion of the light source unit 20 exposed to the light source opening 14, that is, an emission surface 20A of the light source unit 20 that emits ultraviolet light constitutes a portion of the wall surface of the sterilization chamber 60. Therefore, the fluid in the sterilization chamber 60 comes into contact with the emission surface 20A of the light source unit 20. Therefore, the light source unit 20 is cooled by the fluid in the sterilization chamber 60. As a result, light emission efficiency of the light source unit 20 may be increased.

The housing 30 is provided to enclose the sterilization chamber body 10 and the light source unit 20. That is, the housing 30 is disposed to cover the sterilization chamber body 10 and the light source unit 20. Specifically, an inner surface of the housing 30 faces an outer surface of the sterilization chamber body 10. Further, the inner surface of the housing 30 faces an outer surface of the light source unit 20. That is, the inner surface of the housing 30 faces an outer back surface 20B and an outer peripheral surface 20C that constitute the outer surface of the light source unit 20.

The outer region 70 is formed by a gap between the inner surface of the housing 30 and the outer surface of the sterilization chamber body 10 and a gap between the inner surface of the housing 30 and the outer surface of the light source unit 20. A portion of the outer region 70 is a region that faces the inner surface of the housing 30 and the outer surface of the sterilization chamber body 10. The other portion of the outer region 70 is a region that faces the inner surface of the housing 30 and the outer surface of the light source unit 20.

The housing 30 is formed with a housing supply port 31A through which a fluid is supplied. The housing supply port 31A communicates with the outer region 70. That is, the fluid supplied from the housing supply port 31A passes through the outer region 70 and flows into the sterilization chamber 60 from the chamber inlet 12.

Further, the housing 30 is formed with a housing discharge port 32A that discharges a fluid. The housing discharge port 32A communicates with the chamber outlet 13 of the sterilization chamber body 10. Therefore, the fluid sterilized in the sterilization chamber 60 is discharged to the outside from the housing discharge port 32A through the chamber outlet 13.

### 2. Regarding Fluid Flow Path in Fluid Sterilization Device 1

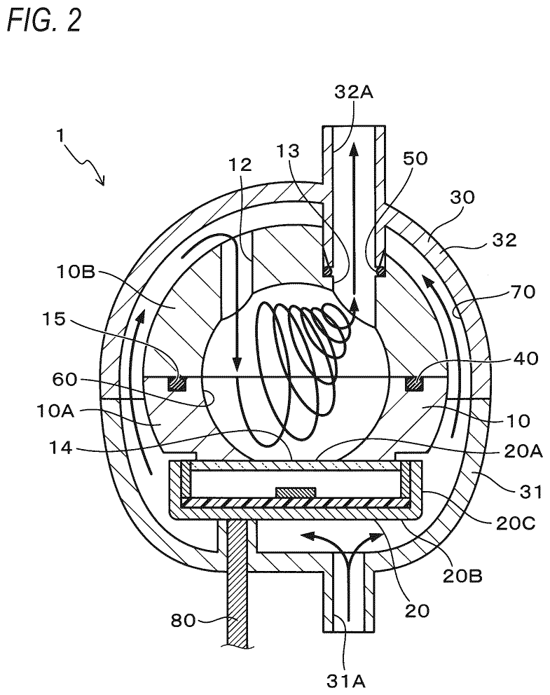

A fluid flow path in the fluid sterilization device 1 will be described with reference to FIG. 2. As illustrated in FIG. 2, the fluid is supplied to the outer region 70 from the housing supply port 31A.

First, the fluid supplied from the housing supply port 31A flows into the gap of the outer region 70 between the inner surface of the housing 30 and the outer back surface 20B of the light source unit 20. At this time, the fluid comes into contact with the outer back surface 20B of the light source unit 20 and cools the light source unit 20. Subsequently, the fluid flows into the gap in the outer region 70 between the inner surface of the housing 30 and the outer peripheral surface 20C of the light source unit 20. At this time, the fluid comes into contact with the outer peripheral surface 20C of the light source unit 20 and cools the light source unit 20. Subsequently, the fluid flows into the gap in the outer region 70 between the inner surface of the housing 30 and the outer surface of the sterilization chamber body 10.

In this way, the fluid supplied from the housing supply port 31A first comes into contact with the outer back surface 20B and the outer peripheral surface 20C, which are the outer surface of the light source unit 20. Therefore, the light source unit 20 is efficiently cooled by the fluid supplied from the housing supply port 31A. As a result, the light emission efficiency of the light source unit 20 may be increased.

Subsequently, the fluid in the outer region 70 flows into the sterilization chamber 60 from the chamber inlet 12 of the sterilization chamber body 10. The fluid that flows into the sterilization chamber 60 advances toward the chamber outlet 13 while maintaining a helical flow. The fluid flows from the chamber outlet 13 to the housing discharge port 32A and is discharged to the outside.

Here, since the sterilization chamber 60 has a concave spherical-shaped wall surface, the fluid in the sterilization chamber 60 forms the helical flow. Further, the chamber inlet 12 and the chamber outlet 13 are configured such that a direction of a central axis of the helical flow, generated by the fluid flowing in from the chamber inlet 12 along the concave spherical-shaped wall surface of the sterilization chamber 60, changes as the helical flow advances from a vicinity of the chamber inlet 12 to the chamber outlet 13.

As illustrated in FIG. 2, the direction of the central axis of the helical flow in the sterilization chamber 60 changes from the chamber inlet 12 toward the chamber outlet 13. Based on a positional relation between the chamber inlet 12 and the chamber outlet 13, the direction of the central axis of the helical flow of the fluid that flows into the sterilization chamber 60 changes to approach a direction of a central axis L3 of the chamber outlet 13.

In the present embodiment, since the direction of the central axis of the helical flow generated immediately after the fluid flows in from the chamber inlet 12 has an angle with respect to the direction of the central axis L3 of the chamber outlet 13, the direction of the central axis of the helical flow changes. In particular, since the angle formed by the direction of the central axis of the helical flow and the direction of the central axis L3 of the chamber outlet 13 has a large angle (angle close to 90°), the angle at which the direction of the central axis of the helical flow changes is large. With such a configuration, in the sterilization chamber 60, fluid stagnation is eliminated, and the flow may be improved. In particular, the flow of the fluid in a vicinity of the chamber outlet 13 may be improved.

In this way, in the sterilization chamber 60, the fluid that flows in from the chamber inlet 12 may be prevented from immediately flowing toward the chamber outlet 13, and a helical flow may be effectively generated. Since the helical flow may be maintained in the entire sterilization chamber 60, the fluid flow path in the sterilization chamber 60 may be lengthened. As a result, a desired cumulative irradiation amount by the ultraviolet light from the light source unit 20 may be secured, and a desired sterilization performance may be secured. Further, a pressure loss may be reduced, and the sterilization efficiency may be increased.

Further, since the helical flow may be maintained in the sterilization chamber 60, the pressure loss of the fluid in the sterilization chamber 60 may be reduced. For this reason, the sterilization efficiency may also be improved.

### 3. Components of Sterilization Chamber Body 10

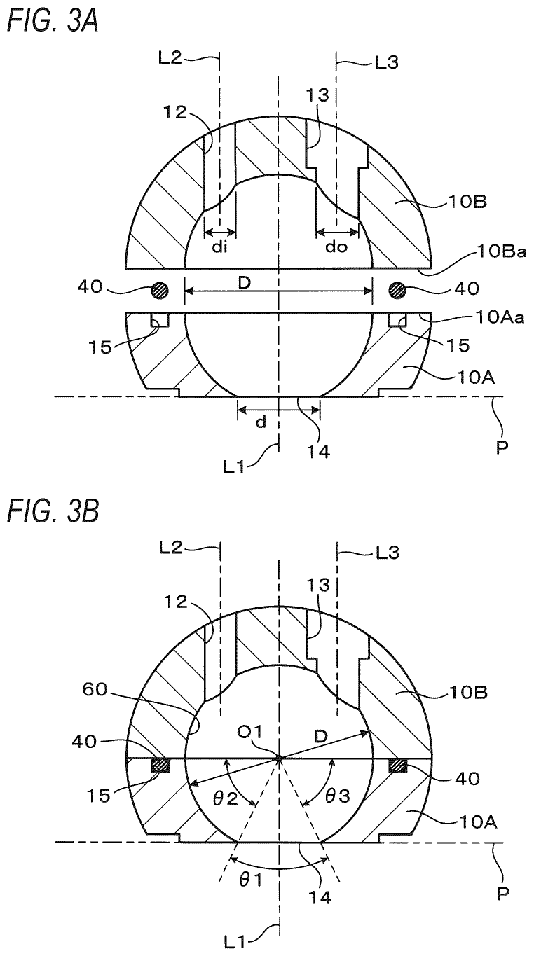

Components of the sterilization chamber body 10 will be described with reference to FIG. 3. The sterilization chamber body 10 includes a plurality of body components divided into at least two portions. An example in which the sterilization chamber body 10 includes two body components will be described.

As illustrated in FIG. 3, the sterilization chamber body 10 is divided into two portions, that is, a first body component 10A and a second body component 10B.

The first body component 10A and the second body component 10B are configured such that the sterilization chamber 60 is divided into two hemispherical shapes. That is, the first body component 10A constitutes one of the plurality of body components that constitute the sterilization chamber body 10, and a wall surface thereof is formed in a semi-concave spherical shape. The second body component 10B constitutes one of the plurality of body components that constitute the sterilization chamber body 10, and a wall surface thereof is formed in a semi-concave spherical shape. The second body component 10B is disposed to face the first body component 10A.

The first body component 10A and the second body component 10B are each formed with ring-shaped boundary surfaces 10Aa, 10Ba, which serve as dividing surfaces. When the ring-shaped boundary surface 10Aa of the first body component 10A and the ring-shaped boundary surface 10Ba of the second body component 10B are aligned with each other, the sterilization chamber 60 is formed therein.

A diameter of the concave spherical surface of the sterilization chamber body 10 is D. A diameter of an opening of the sterilization chamber 60 on the dividing surfaces between the first body component 10A and the second body component 10B is equal to D. By dividing the sterilization chamber body 10 into two portions as described above, the sterilization chamber body 10 may be easily manufactured.

The first body component 10A is formed with the light source opening 14. A plane P that includes the light source opening 14 is a surface parallel to the boundary surfaces 10Aa, 10Ba. That is, a central axis L1 of the light source opening 14 is orthogonal to the boundary surfaces 10Aa, 10Ba. Therefore, the light source opening 14 is formed at a position farthest from the boundary surface 10Aa in the first body component 10A. An edge line of the light source opening 14 is, for example, a circle. Therefore, the light source opening 14 is positioned on the same plane. A diameter of the edge line of the light source opening 14 is d.

A ratio D/d of the diameter D of the sterilization chamber 60 to the diameter d of the light source opening 14 is set in a range of, for example, 1.8 to 2.2. In this case, when a center point O1 of the sterilization chamber 60 is a center, an opening angle θ1 of the light source opening 14 formed in the first body component 10A is about 60°. On the same basis, a sum of angles θ2, θ3 of portions that form the concave spherical shape of the first body component 10A is the remaining 120° (60° each). With this configuration, the fluid that flows in from the chamber inlet 12 reliably hits the concave spherical-shaped wall surface, and the helical flow may be effectively generated. As a result, the pressure loss may be reduced, and the sterilization efficiency may be increased.

The second body component 10B is formed with a chamber inlet 12 and a chamber outlet 13. A central axis L2 of the chamber inlet 12 is offset from the center point O1 of the sterilization chamber 60. The central axis L2 of the chamber inlet 12 is formed parallel to the central axis L1 of the light source opening 14. However, as long as the central axis L2 of the chamber inlet 12 is offset from the center point O1, the central axis L2 of the chamber inlet 12 and the central axis L1 of the light source opening 14 may be in an intersecting positional relation or a twisted positional relation.

The chamber inlet 12 has, for example, a cylindrical tube-shaped inner peripheral surface. An inner diameter of the chamber inlet 12 is di. Since the central axis L2 of the chamber inlet 12 is offset from the center point O1 of the sterilization chamber 60, an edge line of an opening of the chamber inlet 12 closer to the sterilization chamber 60 has a shape that approximates an egg shape.

The chamber inlet 12 is disposed such that the opening of the chamber inlet 12 closer to the sterilization chamber 60 faces a surface of the plane P that includes the light source opening 14 closer to the sterilization chamber 60. In FIG. 3B, the opening of the chamber inlet 12 closer to the sterilization chamber 60 faces downward, and the surface of the plane P that includes the light source opening 14 closer to the sterilization chamber 60 faces upward.

The central axis L3 of the chamber outlet 13 is offset from the center point O1 of the sterilization chamber 60. The central axis L3 of the chamber outlet 13 is formed parallel to the central axis L2 of the chamber inlet 12. Therefore, the central axis L3 of the chamber outlet 13 is also formed parallel to the central axis L1 of the light source opening 14. However, as long as the central axis L3 of the chamber outlet 13 is offset from the center point O1, the central axis L3 of the chamber outlet 13 and the central axis L2 of the chamber inlet 12 may be in an intersecting positional relation or a twisted positional relation. Further, the central axis L3 of the chamber outlet 13 and the central axis L1 of the light source opening 14 may be in an intersecting positional relation or a twisted positional relation.

The chamber outlet 13 has, for example, a cylindrical tube-shaped inner peripheral surface. An inner diameter of the chamber outlet 13 is do. Since the central axis L3 of the chamber outlet 13 is offset from the center point O1 of the sterilization chamber 60, an edge line of an opening of the chamber outlet 13 closer to the sterilization chamber 60 has a shape that approximates an egg shape.

The chamber outlet 13 is disposed such that the opening of the chamber outlet 13 closer to the sterilization chamber 60 faces the surface of the plane P that includes the light source opening 14 closer to the sterilization chamber 60. In FIG. 3B, the opening of the chamber outlet 13 closer to the sterilization chamber 60 faces downward, and the surface of the plane P that includes the light source opening 14 closer to the sterilization chamber 60 faces upward.

As described above, the central axis L1 of the light source opening 14 is orthogonal to the boundary surfaces 10Aa, 10Ba. In this case, the entire boundary surfaces 10Aa, 10Ba are surfaces that have a maximum angle with respect to the central axis L1 of the light source opening 14. Therefore, ultraviolet light that enters the boundary surfaces 10Aa, 10Ba may be reduced, and leakage of ultraviolet light through the boundary surfaces 10Aa, 10Ba may be reduced.

### 4. Positional Relation Among Respective Openings 12, 13, and 14 of Sterilization Chamber Body 10

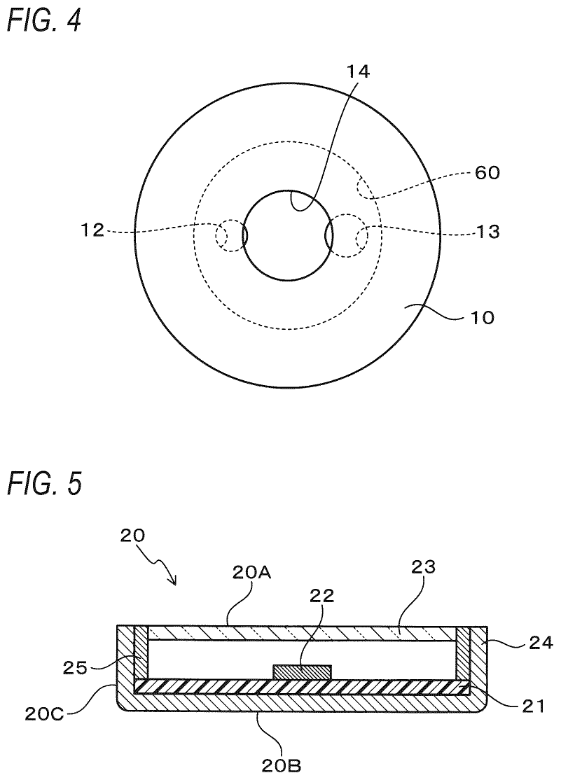

The positional relation among the respective openings 12, 13, and 14 of the sterilization chamber body 10 will be described with reference to FIG. 4. Specifically, the positional relation among the chamber inlet 12, the chamber outlet 13, and the light source opening 14 will be described.

As described above, the central axis L1 of the light source opening 14, the central axis L2 of the chamber inlet 12, and the central axis L3 of the chamber outlet 13 are, for example, parallel to each other. The edge line of the light source opening 14, a cross-sectional shape of the inner peripheral surface of the chamber inlet 12, and a cross-sectional shape of the inner peripheral surface of the chamber outlet 13 each have a circular shape.

The chamber inlet 12 is disposed such that the opening of the chamber inlet 12 faces the surface of the plane P that includes the light source opening 14 closer to the sterilization chamber 60. When viewed from a direction of the central axis L1 of the light source opening 14, at least a portion of the opening of the chamber inlet 12 is disposed not to overlap the light source opening 14. In the present embodiment, when viewed from the direction of the central axis L1 of the light source opening 14, another portion of the opening of the chamber inlet 12 is disposed to overlap the light source opening 14. That is, a position of the chamber inlet 12 is set such that at least a portion of the chamber inlet 12 is outside the light source opening 14 when viewed from a direction illustrated in FIG. 4.

As described above, when viewed from the direction of the central axis L1 of the light source opening 14, at least a portion of the opening of the chamber inlet 12 is disposed not to overlap the light source opening 14. The central axis L1 of the light source opening 14 is parallel to the central axis L2 of the chamber inlet 12. That is, even when viewed from a direction of the central axis L2 of the chamber inlet 12, at least a portion of the opening of the chamber inlet 12 is disposed not to overlap the light source opening 14.

Therefore, the fluid that flows in from the chamber inlet 12 does not all advance toward the light source opening. At least a portion of the fluid that flows in hits the concave spherical-shaped wall surface of the sterilization chamber 60. In this way, when at least a portion of the fluid that flows in hits the concave spherical-shaped wall surface, a helical flow may be generated in the sterilization chamber. Then, by generating the helical flow immediately after the fluid flows into the sterilization chamber 60, the helical flow may be maintained in an entire region of the concave spherical-shaped sterilization chamber sterilization chamber 60. Therefore, the desired cumulative irradiation may be ensured, and the desired sterilization performance may be ensured.

In addition to the above configuration, when viewed from the direction of the central axis L1 of the light source opening 14, the entire opening of the chamber inlet 12 may be disposed not to overlap the light source opening 14. That is, when viewed from the direction of the central axis L2 of the chamber inlet 12, the entire opening of the chamber inlet 12 may be disposed not to overlap the light source opening 14. In this case, the helical flow may be effectively generated in the sterilization chamber 60. By generating a stronger helical flow immediately after the fluid flows into the sterilization chamber 60, the helical flow may be maintained in the entire region of the concave spherical-shaped sterilization chamber 60.

The chamber outlet 13 is disposed such that an opening of the chamber outlet 13 faces the surface of the plane P that includes the light source opening 14 closer to the sterilization chamber 60. When viewed from the direction of the central axis L1 of the light source opening 14, at least a portion of the opening of the chamber outlet 13 is disposed not to overlap the light source opening 14. In the present embodiment, when viewed from the direction of the central axis L1 of the light source opening 14, another portion of the opening of the chamber outlet 13 is disposed to overlap the light source opening 14. That is, a position of the chamber outlet 13 is also set such that at least a portion of the chamber outlet 13 is outside the light source opening 14 when viewed from a direction illustrated in FIG. 4.

As described above, when viewed from the direction of the central axis L1 of the light source opening 14, at least a portion of the opening of the chamber outlet 13 is disposed not to overlap the light source opening 14. The central axis L1 of the light source opening 14 is parallel to the central axis L3 of the chamber outlet 13. That is, even when viewed from the direction of the central axis L3 of the chamber outlet 13, at least a portion of the opening of the chamber outlet 13 is disposed not to overlap the light source opening 14.

Therefore, at least a portion of the fluid that flows toward the chamber outlet 13 flows toward the chamber outlet 13 while hitting the concave spherical-shaped wall surface of the sterilization chamber 60. The fluid that flows toward the chamber outlet 13 may be in a state of maintaining the helical flow. As a result, the fluid that flows from the chamber inlet 12 toward the chamber outlet 13 may maintain the helical flow throughout. Since the helical flow may be maintained in the sterilization chamber 60, the pressure loss of the fluid in the sterilization chamber 60 may be reduced, and the sterilization efficiency may be increased. Therefore, the desired cumulative irradiation may be secured, and the desired sterilization performance may be secured.

In addition to the above configuration, when viewed from the direction of the central axis L1 of the light source opening 14, the entire opening of the chamber outlet 13 may be disposed not to overlap the light source opening 14. That is, when viewed from the direction of the central axis L3 of the chamber outlet 13, the entire opening of the chamber outlet 13 may be disposed not to overlap the light source opening 14. In this case, a strong helical flow may be maintained in the fluid that flows toward the chamber outlet 13.

The inner diameter of the chamber outlet 13 is formed larger than the inner diameter of the chamber inlet 12. By reducing the inner diameter of the chamber inlet 12, a flow rate of the fluid that flows into the sterilization chamber 60 may be increased, and the helical flow may be effectively generated. Further, by increasing the inner diameter of the chamber outlet 13, the fluid that flows out may flow out in the state of maintaining the helical flow. Therefore, the pressure loss in the vicinity of the chamber outlet 13 may be reduced, and the sterilization efficiency may be increased.

When viewed from the direction illustrated in FIG. 4, a ratio of an area of the chamber inlet 12 or the chamber outlet 13 that is outside the light source opening 14 is preferably 50% or more, and more preferably larger. Accordingly, the helical flow may be easily formed. The ratio of the area needs to be set according to sizes of the diameter D of the sterilization chamber 60, the inner diameter di of the chamber inlet 12, and the inner diameter do of the chamber outlet 13.

### 5. Configurations of Boundary Surfaces 10Aa, 10Ba, and First Seal Member 40

The boundary surface 10Aa of the first body component 10A, the boundary surface 10Ba of the second body component, and the first seal member 40 will be described with reference to FIGS. 3A and 3B.

The boundary surface 10Aa of the first body component 10A is formed in a ring shape. The boundary surface 10Aa is formed with a ring-shaped concave groove 15. The concave groove 15 is provided to fit the ring-shaped first seal member 40 and fix a position of the first seal member 40 on the boundary surface 10Aa. A cross-sectional shape of the concave groove 15 may be any shape, such as a rectangular shape, a V-shape, or a circular shape, as long as the first seal member 40 may be fitted into the concave groove 15.

The first seal member 40 is made of fluororubber or fluoroelastomer. Any of these materials is an elastic material that is resistant to deterioration caused by ultraviolet light and has a high reflectance to ultraviolet light. The first seal member 40 is exemplified as having a ring shape with a circular-shaped cross section. However, the first seal member 40 may have any cross-sectional shape.

The first seal member 40 is fitted into the concave groove 15. By fitting the first seal member 40 into the concave groove 15, the first seal member 40 on the boundary surface 10Aa of the first body component 10A may be fixed and stabilized, and may be positioned. Further, by fitting the first seal member 40 into the concave groove 15, the exposed area of the first seal member 40 may be reduced, and the first seal member 40 may be prevented from being directly irradiated with ultraviolet light. Therefore, a server life of the first seal member 40 may be improved.

As illustrated in FIG. 3B, in the fluid sterilization device 1, the boundary surface 10Aa of the first body component 10A and the boundary surface 10Ba of the second body component 10B are disposed to face each other. The sterilization chamber body 10 is disposed inside the housing 30 to be pressed by the housing 30 in an upper and lower direction in FIG. 3B. By the pressing, the first seal member 40 comes into close contact with the boundary surface 10Aa of the first body component 10A and the boundary surface 10Ba of the second body component 10B over an entire circumferential direction. In this way, the first seal member 40 partitions the sterilization chamber 60 and the outer region 70.

In this state, the boundary surface 10Aa of the first body component 10A and the boundary surface 10Ba of the second body component 10B are in a state of being in close contact with each other or in a state of having a slight gap therebetween. In this way, the sterilization chamber 60 is formed by a semi-concave spherical shape of the first body component 10A and a semi-concave spherical shape of the second body component 10B, and the sterilization chamber body 10 is formed.

According to the above configuration, even if the fluid temporarily enters from the sterilization chamber 60 into the boundary surfaces 10Aa, 10Ba between the first body component 10A and the second body component 10B, the first seal member 40 prevents the fluid from flowing outside of the boundary surfaces. That is, the boundary surfaces 10Aa, 10Ba between the first body component 10A and the second body component 10B are sealed by the first seal member 40, and leakage of the fluid between the sterilization chamber 60 and the outer region 70 may be prevented.

Depending on dimensional accuracy and surface roughness of the boundary surfaces 10Aa, 10Ba, the boundary surfaces 10Aa, 10Ba may come into contact with each other at a portion in the circumferential direction and be separated from each other at the remaining portion in the circumferential direction. Even in this case, the first seal member 40 comes into close contact with the boundary surface 10Ba of the second body component 10B over the entire circumference. Therefore, the same effect as described above is exerted.

Further, since the first seal member 40 is made of fluororubber or fluoroelastomer, even if the ultraviolet light from the light source unit 20 enters the boundary surfaces 10Aa, 10Ba between the first body component 10A and the second body component 10B, the ultraviolet light may be reflected by the first seal member 40. Therefore, ultraviolet light may be prevented from leaking from the boundary surfaces 10Aa, 10Ba between the first body component 10A and the second body component 10B to an outside of the sterilization chamber body 10.

Further, since the first seal member 40 is fitted into the concave groove 15, the first seal member 40 is not directly irradiated with ultraviolet light from the light source opening 14. Therefore, the server life of the first seal member 40 may be improved.

In the present embodiment, the sterilization chamber body 10 is formed by two body components, the first body component 10A and the second body component 10B. The sterilization chamber body 10 may also be formed by three or more body components. Also in this case, by disposing the first seal member 40 on the boundary surface with each body component, leakage of the fluid between the sterilization chamber 60 and the outer region 70 may be prevented, and leakage of ultraviolet light to the outside of the sterilization chamber body 10 may be prevented.

Further, in the present embodiment, the concave groove 15 is provided in the first body component 10A, and the concave groove 15 may be provided in the second body component 10B, or may be provided in both.

### 6. Configuration of Light Source Unit 20

A configuration of the light source unit 20 will be described with reference to FIG. 5. FIG. 5 is a cross-sectional view illustrating the configuration of the light source unit 20. The light source unit 20 is disposed to close the light source opening 14 of the sterilization chamber body 10. Further, the light source unit 20 is disposed such that an ultraviolet light emission side thereof faces the sterilization chamber 60. The ultraviolet light emitted from the light source unit 20 enters the sterilization chamber 60 from the light source opening 14.

The light source unit 20 includes a mounting substrate 21, a light-emitting element 22, a window member 23, a light source housing 24, and a gasket 25. A shape of the entire light source unit 20 is, for example, a disk shape. However, the shape of the light source unit 20 may be any shape.

The mounting substrate 21 is a substrate having a mounting surface. The mounting substrate 21 is formed with a wiring pattern. A wiring 80 that supplies power is connected to a back surface of the mounting substrate 21.

The light-emitting element 22 is an element that emits ultraviolet light. For example, the light-emitting element 22 uses a group III nitride semiconductor, and has an emission wavelength of 200 to 280 nm. Since the emission wavelength is in the UVC region, the fluid may be efficiently sterilized. The light-emitting element 22 may be directly mounted on the mounting surface of the mounting substrate 21, or a packaged LED package may be mounted on the mounting surface of the mounting substrate 21. The LED package is a unit in which the light-emitting element 22 is disposed in a housing and sealed by a glass plate or a lens. Various elements (for example, Zener diodes) or the like necessary for driving and protecting the light-emitting element 22 are mounted on the mounting surface of the mounting substrate 21.

The window member 23 is a circular-shaped glass plate and is disposed on the gasket 25. The window member 23 is made of quartz. A material other than quartz may be used as long as the material transmits ultraviolet light. For example, sapphire or the like may be used. The window member 23 is not limited to being in a plate shape and may be in the form of a lens, for example, a TIR lens, a fly-eye lens, or a Fresnel lens.

The light source housing 24 is provided to cover other portions while leaving at least a vicinity of a center of the window member 23 uncovered. The light source housing 24 is provided to continuously cover the back surface and side surfaces of the mounting substrate 21 and side surfaces of the window member 23. The light source housing 24 may be formed by one member or may be formed by a plurality of members.

The light source housing 24 is formed of a material having high heat dissipation. For example, the light source housing 24 is formed of a metal such as SUS or Al, a resin material having high heat dissipation, or the like. Since the light source housing 24 of the light source unit 20 comes into contact with the fluid, the light source unit 20 may be efficiently cooled.

The gasket 25 is formed in a ring shape, is disposed on the mounting substrate 21 along a vicinity of end portions of the mounting substrate 21. The light-emitting element 22 and various elements are positioned inside the gasket 25. A height of the gasket 25 is set to be higher than the light-emitting element 22 and various elements. The gasket 25 is made of an elastic material that is resistant to ultraviolet light. The first seal member 40 may be made of the same material.

The gasket 25 is elastically deformed and comes into close contact with the mounting substrate 21, the window member 23, and the light source housing 24. Accordingly, an internal space surrounded by the light source housing 24, the window member 23, and the gasket 25 is sealed so that the fluid does not leak into the internal space. Therefore, the fluid may be prevented from entering the region in which the light-emitting element 22 and various elements are disposed. The gasket 25 may come into close contact with only the mounting substrate 21 and the window member 23, or may come into close contact with only the window member 23 and the light source housing 24.

Here, the outer surface of the light source unit 20 includes the emission surface 20A that emits ultraviolet light, the outer back surface 20B positioned on the back surface of the emission surface, and the outer peripheral surface 20C. The emission surface 20A is positioned corresponding to the light source opening 14, and is formed by a portion of the window member 23 that is not covered by the light source housing 24. That is, the emission surface 20A is formed by a surface of the window member 23. The outer back surface 20B is formed by a portion on a back surface of the light source housing 24. The outer peripheral surface 20C is formed by a portion of an outer peripheral surface of the light source housing 24.

### 7. Configuration of Housing 30 and Second Seal Member 50

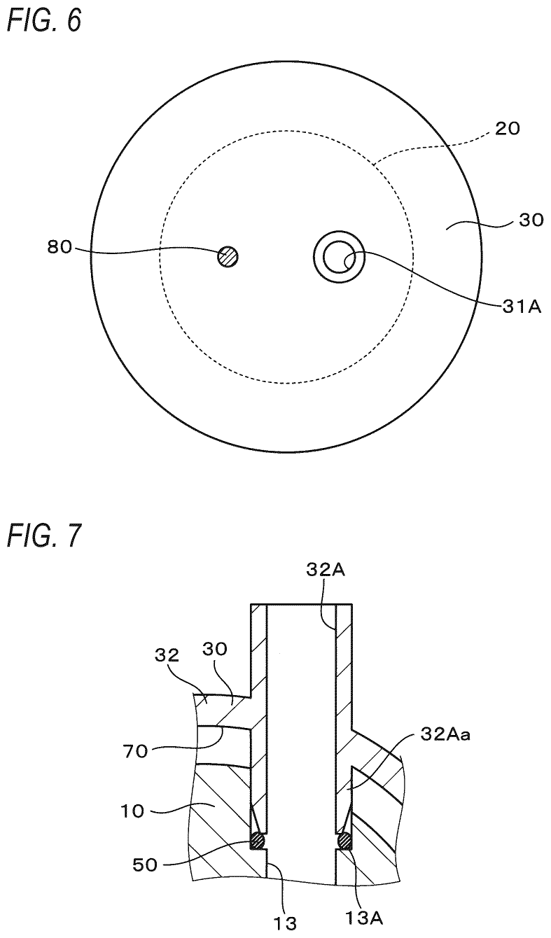

A configuration of the housing 30 and the second seal member 50 will be described with reference to FIG. 1, FIG. 6, and FIG. 7. As described above, the housing 30 is provided to enclose the sterilization chamber body 10 and the light source unit 20. The housing 30 includes a first housing member 31 and a second housing member 32. A dividing position of the first housing member 31 and the second housing member 32 may be freely set. Further, the housing 30 may be formed by one member, or may be formed by three or more members. A seal structure (not illustrated) is provided at a joint portion between the first housing member 31 and the second housing member 32.

The first housing member 31 covers a portion of the outer surface of the sterilization chamber body 10 and the outer surface of the light source unit 20. Therefore, a portion of the outer region 70 is formed between an inner surface of the first housing member 31 and the outer surface of the sterilization chamber body 10, and the outer surface of the light source unit 20.

The first housing member 31 includes the housing supply port 31A. The housing supply port 31A is formed in a tubular shape, such as a cylindrical tube shape or a polygonal tube shape. As illustrated in FIG. 1 and FIG. 6, the housing supply port 31A is disposed to face the outer back surface 20B of the light source unit 20. When viewed from a direction of a central axis of the housing supply port 31A, at least a portion of an opening of the housing supply port 31A is set to face the outer back surface of the light source unit 20. Accordingly, the fluid that flows into the outer region 70 from the housing supply port 31A may directly hit the light source unit 20, and cooling efficiency of the light source unit 20 may be improved.

In particular, when viewed from the direction of the central axis of the housing supply port 31A, the entire opening of the housing supply port 31A may be set to face the outer back surface 20B of the light source unit 20. The cooling efficiency of the light source unit 20 may be further improved.

Further, the first housing member 31 is provided with an opening 31B through which the wiring 80 that connects the light source unit 20 and the outside passes. The opening 31B has, for example, a cylindrical tube shape, and one end of the cylindrical tube is in contact with the outer back surface 20B of the light source unit 20. By passing the wiring 80 through an inside of the cylindrical tube of the opening 31B, a connection between the light source unit 20 and the wiring 80, and the wiring 80 do not come into contact with the fluid.

The second housing member 32 covers the remaining portion of the outer surface of the sterilization chamber body 10. A portion of the outer region 70 is formed between an inner surface of the second housing member 32 and the outer surface of the sterilization chamber body 10.

The second housing member 32 is formed with the housing discharge port 32A. The housing discharge port 32A is connected to the chamber outlet 13 of the sterilization chamber body 10. A connection structure between the chamber outlet 13 of the sterilization chamber body 10 and the housing discharge port 32A of the housing 30 will be described with reference to FIG. 7.

As illustrated in FIG. 7, the housing discharge port 32A includes a cylindrical tube-shaped portion 32Aa that protrudes toward the chamber outlet 13, and is connected to the chamber outlet 13 by fitting the cylindrical tube-shaped portion 32Aa into the chamber outlet 13. Further, a region of the chamber outlet 13 closer to the housing discharge port 32A has a larger inner diameter than other regions, and the inner diameter thereof is approximately equal to an outer diameter of the cylindrical tube-shaped portion 32Aa.

Due to this difference in inner diameter, a stepped portion 13A is formed in the chamber outlet 13. The ring-shaped second seal member 50 is disposed in the stepped portion 13A. The second seal member 50 is made of the same material as the first seal member 40. That is, the second seal member 50 is made of fluororubber or fluoroelastomer.

The second seal member 50 is formed in a ring shape. The second seal member 50 is disposed to be sandwiched by a boundary surface between the chamber outlet 13 and the housing discharge port 32A. The second seal member 50 is elastically deformed by the pressing from the housing 30, and comes into close contact with both the stepped portion 13A of the chamber outlet 13 and a distal end of the cylindrical tube-shaped portion 32Aa of the housing discharge port 32A. With such a structure, the second seal member 50 seals the boundary surface between the chamber outlet 13 and the housing discharge port 32A. Therefore, the second seal member 50 prevents the fluid from leaking between the chamber outlet 13 and the outer region 70 through the boundary surface between the chamber outlet 13 and the housing discharge port 32A.

### 8. Water Flow Simulation

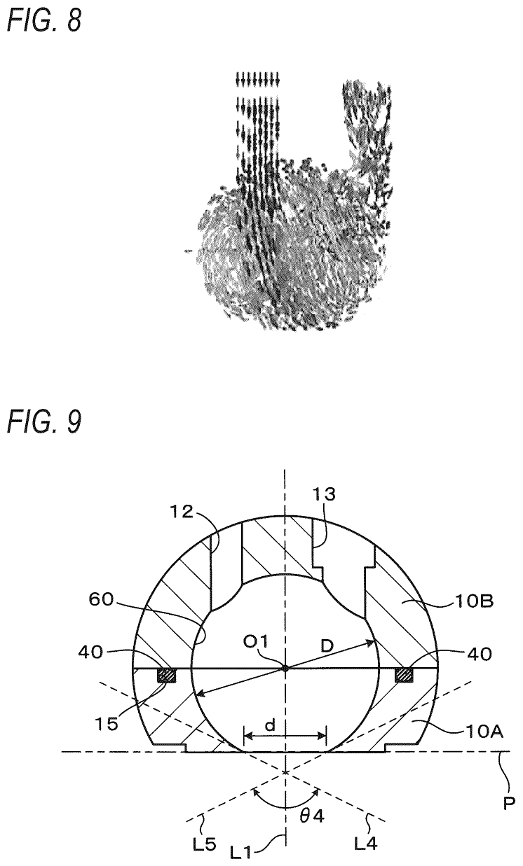

The sterilization chamber 60 according to the present embodiment was modeled, and a water flow simulation was performed. A water flow simulation result shows that a helical flow is formed in the sterilization chamber 60 as illustrated in FIG. 8.

When a flow rate per unit time of water flowing through the sterilization chamber 60 was 8 L/sec, a time from when the water flows in from the chamber inlet 12 to when the water flows out from the chamber outlet 13, that is, a residence time in the sterilization chamber 60 was 0.14 sec. It was confirmed that sterilization performance of the outflowing water was very high, and sterilization or inactivation of target bacteria and viruses was 90% or more.

From the above, the sterilization chamber body 10 may be configured such that when the flow rate per unit time of the fluid flowing through the sterilization chamber 60 is 0.5 to 50 L/sec, the residence time of the fluid in the sterilization chamber 60 is 0.02 to 2 sec. Accordingly, the desired cumulative irradiation may be ensured, and the desired sterilization performance may be ensured.

### 9. Angle θ4 in Sterilization Chamber 60 Formed by Tangent Lines at Light Source Opening 14

An angle θ4 in the sterilization chamber 60 formed by tangent lines at the light source opening 14 will be described with reference to FIG. 9.

In FIG. 9, L4, L5 are tangent lines in the sterilization chamber 60 at the light source opening 14 in a cross section of the sterilization chamber body 10 that passes through the central axis L1 of the light source opening 14. An angle formed by the tangent lines L4, L5 is θ4.

As described above, the ratio D/d of the diameter D of the sterilization chamber 60 to the diameter d of the light source opening 14 is set in the range of 1.8 to 2.2. When the ratio D/d is 2.0, the angle θ4 formed by the tangent lines L4, L5 is 120°. When the ratio D/d is 1.8, the angle θ4 is about 113°. When the ratio D/d is 2.2, the angle θ4 is about 126°.

When the ratio D/d is in the range of 1.8 to 2.0, the formed angle θ4 is 113° to 120°. The reason will be described later, and it is more preferable that the ratio D/d is set in the range of 1.8 to 2.0.

### 10. Light Distribution Characteristic of Light-Emitting Element 22

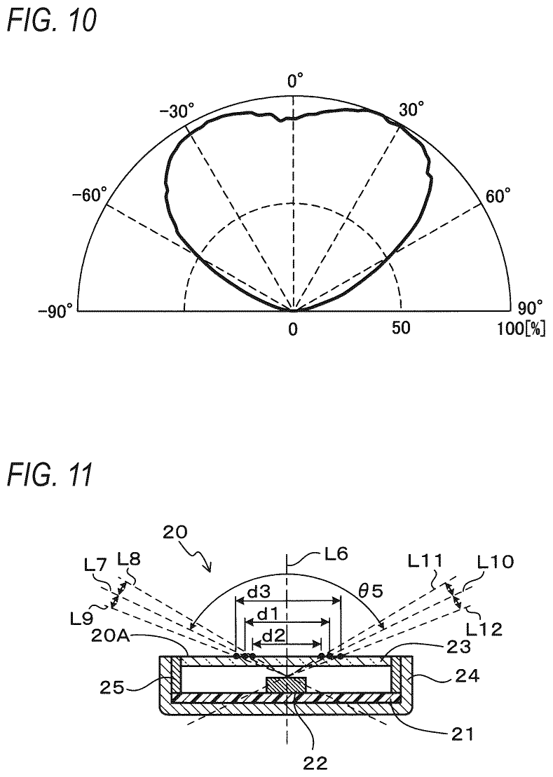

A light distribution characteristic of the light-emitting element 22 will be described with reference to FIG. 10. As illustrated in FIG. 10, the light distribution characteristic of the light-emitting element 22 forms a heart shape. Specifically, the light-emitting element 22 has two maximum illuminance axes that are symmetrical with respect to an optical axis, positioned in a center direction in a spread of the light distribution characteristic (position of 0° in FIG. 10), in a cross section that passes through the optical axis. There are two maximum illuminance axes, one around +30° and one around −30°.

In the light distribution characteristic illustrated in FIG. 10, the axes at which the illuminance is 50% of the maximum illuminance are positioned around +60° and around −60°. Therefore, in the light distribution characteristic illustrated in FIG. 10, the half-value angle, which is an inter-axis angle at which the illuminance is 50% of the maximum illuminance, is 120°. The reason will be described later, and the half-value angle may be set in a range of 110° to 130°.

### 11. Relation Between Light Source Opening 14 and Half-Value Angle θ5 of Light-Emitting Element 22

A relation between the light source opening 14 and the half-value angle θ5 of the light-emitting element 22 in the sterilization chamber 60 will be described with reference to FIG. 9 to FIG. 11.

The sterilization chamber body 10 and the light source unit 20 are disposed such that the central axis L1 of the light source opening 14 illustrated in FIG. 9 coincides with an optical axis L6 of the light-emitting element 22 illustrated in FIG. 11.

As illustrated in FIG. 10 and FIG. 11, the half-value angle θ5 of the light-emitting element 22 is an angle formed by axes L7, L10 at which the illuminance is 50% of the maximum illuminance. The half-value angle θ5 is set, for example, around 120°. For example, the half-value angle θ5 is set in a range of −10° to +10° centered around 120°. That is, the half-value angle θ5 is set in a range of 110° to 130°.

As illustrated in FIG. 11, on the emission surface 20A of the light source unit 20, a diameter of a region included in a range of the half-value angle θ5 of the light-emitting element 22 is d1. That is, on the emission surface 20A of the light source unit 20, a distance between intersections with the axes L7, L10 that corresponds to the half-value angle θ5 of the light-emitting element 22 is d1.

Further, on the emission surface 20A of the light source unit 20, a diameter of a region included in a range of −10° around the half-value angle θ5 of the light-emitting element 22 is d2. That is, on the emission surface 20A of the light source unit 20, a distance between intersections with axes L8, L11 that correspond to −10° around the half-value angle θ5 of the light-emitting element 22 is d2. The axes L8, L11 that correspond to −10° around the half-value angle θ5 of the light-emitting element 22 are an axis of +5° from the axis L7 and an axis of −5° from the axis L10. In FIG. 11, a positive angle is a clockwise angle.

Further, on the emission surface 20A of the light source unit 20, a diameter of a region included in a range of +10° around the half-value angle θ5 of the light-emitting element 22 is d3. That is, on the emission surface 20A of the light source unit 20, a distance between intersections of axes L9, L12 that correspond to +10° around the half-value angle θ5 of the light-emitting element 22 is d3. The axes L9, L12 that correspond to +10° around the half-value angle θ5 of the light-emitting element 22 are an axis of −5° from the axis L7 and an axis of +5° from the axis L10.

The light source opening 14 is formed such that the edge line of the light source opening 14 is included in a region that constitutes −10° to +10° around the half-value angle θ5 of the light-emitting element 22. Therefore, in FIG. 11, one edge line of the light source opening 14 is positioned between the axis L8 and the axis L9, and the other edge line of the light source opening 14 is positioned between the axis L11 and the axis L12. That is, the diameter d of the light source opening 14 is included in the diameters d2 to d3 of the region included in the range of −10° to +10° around the half-value angle θ5 of the light-emitting element 22.

As described above, the edge line of the light source opening 14 is positioned to be included in the region that constitutes −10° to +10° around the half-value angle θ5 of the light-emitting element 22. Further, −10° to +10° around the half-value angle θ5 of the light-emitting element 22 is an angle at which the illuminance is approximately 50% of the maximum illuminance. Therefore, the region that constitutes −10° to +10° around the half-value angle θ5 of the light-emitting element 22 is a region in which the illuminance is approximately 50% or more of the maximum illuminance. That is, the illuminance of the ultraviolet light emitted from the light source opening 14 has an illuminance of approximately 50% or more of the maximum illuminance. An inside of the sterilization chamber 60 is irradiated with the ultraviolet light having the illuminance of approximately 50% or more of the maximum illuminance, and the fluid that flows through the sterilization chamber 60 may be efficiently sterilized.

In particular, the half-value angle θ5 is 110° to 130°. For example, when the half-value angle θ5 is 110°, the following occurs. A range from +55° to −55° with respect to the optical axis L6, positioned in the central direction as the central axis in a spread of a light distribution characteristic of the light-emitting element 22, has an illuminance of 50% or more. The region that constitutes −10° to +10° around the half-value angle θ5 is a range of a light distribution angle of 100° to 120° when the optical axis L6 is the central axis. In this case, the edge line of the light source opening 14 is formed to be included in the range of the light distribution angle of 100° to 120°.

When the half-value angle θ5 is 120°, the edge line of the light source opening 14 is formed to be included in a range of a light distribution angle of 110° to 130° when the optical axis L6 is the central axis. When the half-value angle θ5 is 130°, the edge line of the light source opening 14 is formed to be included in a range of a light distribution angle of 120° to 140° when the optical axis L6 is the central axis.

By setting the half-value angle θ5 to 110° to 130° in this manner, ultraviolet light with high illuminance may be emitted into the concave spherical-shaped sterilization chamber 60. Therefore, the sterilization efficiency may be increased.

Further, the light-emitting element 22 has two maximum illuminance axes that are symmetrical with respect to the optical axis L6, positioned in the center direction in the spread of the light distribution characteristic, in a cross section that passes through the optical axis L6. That is, the light distribution characteristic of the light-emitting element 22 has a heart shape. By using the light-emitting element 22 having such a light distribution characteristic, the inside of the sterilization chamber 60 may be thoroughly irradiated with the ultraviolet light. As a result, the sterilization efficiency may be increased.

Further, the edge line of the light source opening 14 is formed in a circular shape. Accordingly, ultraviolet light having a desired illuminance may be appropriately emitted into the sterilization chamber 60. As a result, the sterilization efficiency may be increased.

The ratio D/d of the diameter D of the sterilization chamber 60 to the diameter d of the light source opening 14 is set in the range of 1.8 to 2.2. By setting the ratio D/d in the range of 1.8 to 2.2, the inside of the concave spherical-shaped sterilization chamber 60 may be irradiated with the ultraviolet light having the desired illuminance.

In particular, when the half-value angle θ5 is 120° and the ratio D/d is 2.0, boundary surfaces of the half-value angle θ5 come to be in a state in which the boundary surfaces coincide with the tangent lines L4, L5 at the light source opening 14 in the sterilization chamber 60. Therefore, when the half-value angle θ5 is 120° and the ratio D/d is 2.0, the inside of the concave spherical-shaped sterilization chamber 60 may be most appropriately irradiated with the ultraviolet light. Therefore, the half-value angle θ5 may be 110° to 130°, and the ratio D/d may be set in the range of 1.8 to 2.2. With such a configuration, the illuminance of the ultraviolet light emitted from the light source opening 14 may be made equal to or higher than a half value thereof, and the sterilization efficiency may be increased.

The light-emitting element 22 is disposed such that the optical axis L6, positioned in the center direction in the spread of the light distribution characteristic, coincides with the central axis L1 of a circle that is the edge line of the light source opening 14. Accordingly, the inside of the sterilization chamber 60 may be irradiated with the ultraviolet light having the desired illuminance.

What is claimed is:

1. A fluid sterilization device comprising:
a sterilization chamber body that includes a sterilization chamber for a fluid, a wall surface of the sterilization chamber being formed in a concave spherical shape, the sterilization chamber body being formed such that a light source opening, a chamber inlet that allows the fluid to flow into the sterilization chamber, and a chamber outlet that allows the fluid to flow out of the sterilization chamber are formed to open into the sterilization chamber; and
a light source unit configured to close the light source opening and emit ultraviolet light from the light source opening into the sterilization chamber, wherein
the light source unit includes a light-emitting element that emits ultraviolet light, and
the light source opening is formed such that an edge line of the light source opening is included in a region that constitutes −10° to +10° around a half-value angle the light-emitting element.

2. The fluid sterilization device according to claim 1, wherein
the half-value angle is 110° to 130°.

3. The fluid sterilization device according to claim 1, wherein
the light-emitting element has two maximum illuminance axes that are symmetrical with respect to an optical axis, positioned in a center direction in a spread of a light distribution characteristic, in a cross section that passes through the optical axis.

4. The fluid sterilization device according to claim 1, wherein
the edge line of the light source opening is formed in a circular shape.

5. The fluid sterilization device according to claim 4, wherein
a ratio D/d of a diameter D of the sterilization chamber to a diameter d of the light source opening is set in a range of 1.8 to 2.2.

6. The fluid sterilization device according to claim 4, wherein
the light-emitting element is disposed such that the optical axis, positioned in the central direction in the spread of the light distribution characteristic, coincides with a central axis of a circle that is the edge line of the light source opening.

7. The fluid sterilization device according to claim 1, wherein
the chamber inlet and the chamber outlet are disposed to face a surface of a plane that includes the light source opening, the surface being arranged at a side of the sterilization chamber.
